(19) United States
(12) Patent Application Publication
(10) Pub. No.: US 2006/0131332 A1
(43) Pub. Date: Jun. 22, 2006

(54) Beverage mixing and dispensing apparatus and pumps for use therein

(76) Inventor: Richard Anthony Khalaf, Beirut (LB)

Correspondence Address: BREINER & BREINER, L.L.C., P.O. BOX 19290, ALEXANDRIA, VA, 22320-0290, US

(21) Appl. No.: 10/536,267

(22) PCT Filed: Nov. 26, 2003
(86) PCT No.: PCT/IB03/05431

§ 371 Date: May 25, 2005

(30) Foreign Application Priority Data
Nov. 26, 2002 (LB) 6599

(51) Int. Cl. B67D 5/52

(52) U.S. Cl. 222/135

(57) ABSTRACT

Apparatus for dispensing beverages formed by mixing carbonated water and a flavoring syrup are described. Dispensing takes place via a pump which is driven by the carbonated water under pressure and which has a pumping chamber adapted to pump syrup from a syrup container to an outlet. The relative sizes of the two pumping chambers determine the mixing ratio between carbonated water and syrup, outlet pipes leading to a common mixer and dispensing aperture. In a preferred embodiment, the internal geometry of one of the pumping chamber may be changed whereby to vary the volumetric ratio between the liquids pumped through the two respective chambers.

This invention relates to beverage mixing and dispensing apparatus and parts for use therein.

The production of carbonated beverages constitutes a major worldwide industry. It falls into two distinct parts, viz. the manufacture of carbonated beverages, their sealing into pressurised containers, and the distribution and sale of such pressurised containers. These may be cans, or in recent decades, high-strength bottles. The convenience of pre-packaged beverages is widely acknowledged and many millions of such pre-packaged beverage containers are sold throughout the world every day.

A separate area is the production of carbonated beverages essentially at the point of consumption. These are made by mixing carbonated water with a so-called “syrup”, i.e. a concentrated preparation which needs to be diluted with carbonated water to provide the beverage in question. Originally, such dispensing systems were used exclusively in beverage-providing establishments, for example inns, restaurants and hotels. This, however, reaches only part of the market and numerous attempts have been made, some of them successfully commercialised, to provide a smaller scale apparatus which can be used, for example, in a domestic setting. The three requirements, viz. a supply of carbon dioxide under pressure, a water supply and a supply of syrup are easily provided and numerous types of apparatus have been developed for mixing the three to provide, as a flowing beverage stream, the carbonated drink of choice.

There are numerous patents directed to beverage dispenser systems, particularly designed for low-volume usage. A feature of all such systems is the provision of appropriate mixing devices to ensure that the ratio of dilution of the syrup is set at the desired level. U.S. Pat. No. 4,966,306 discloses a post-mix beverage dispensing valve for a beverage dispenser which has a volumetric ratio control device incorporated therein to provide positive ratio control. A syrup piston and a soda piston are linked together, operating in separate syrup and soda chambers, and flow control valves are provided to regulate the operation of the apparatus. In this, as suggested in other documents, the pressure from a supply of carbon dioxide, i.e. the pressurised soda, acts as the driving force for the dispensing mechanism.

U.S. Pat. No. 5,082,143 describes a simple beverage mixing dispensing system in which again syrup is mixed with carbonated water and then dispensed. The carbon dioxide pressure operates to move liquid through the system, but the system there described is rendered more complex by the provision of electric solenoid controlled valves.

U.S. Pat. No. 5,012,837, which represents the closest prior art known to the applicant, describes an alternative approach where a housing assembly including two gear pumps is used. One of the gear pumps acts as a liquid powered motor in response to the pressure of a flow of carbonated water, which drives the other gear pump which acts to pump the syrup.

We have now found that by improved pump design, it is possible to produce simple apparatus for dispensing carbonated beverages with improved functionality, including the ability to vary within preset limits the ratio of syrup to water, and which is simple to disassemble and clean as necessary.

According to a first feature of the present invention, there is provided a carbonated beverage dispensing apparatus comprising a dispensing pump housing including a pair of generally cylindrical pump chambers, fluid impeller means rotatable about the axes of each chamber, the impellers being linked together for common rotation, and wherein each cylindrical chamber has a fluid inlet and a fluid outlet, the respective fluid inlets being connectable to a source of syrup and a source of carbonated water under pressure, and the outlets of the two chambers being brought together to cause syrup and carbonated water to mix to produce the desired beverage, each impeller being in the form of a central body having movable vanes thereon, the ends of the vanes distal from the central body being adapted to sweep round the radially outer surface of the respective chamber. Preferably the vanes are spring biased outwardly to ensure contact of the outer ends of the vanes with the outer periphery of the chambers.

Preferably the outlets are brought together in an appropriate mixing chamber or mixing valve, though they may, if desired, simply be brought to a common point from which syrup and carbonated water may drop into a waiting beverage container. This is, however, less preferred since the degree of mixing thereby achieved is generally less and, prior to consumption, the beverage in the container may need to be stirred or otherwise agitated, for example by using a so-called swizzle stick, to ensure complete mixing.

We have found that, in contrast to the gear pump arrangement described in U.S. Pat. No. 5,012,837, the use of pump chambers with bladed impellers provides a considerably more satisfactory and flexible system. Preferably the chambers are coaxial and a common shaft rigidly connects the two impellers. The chambers may vary in size and aspect ratio. In a simple construction, the chambers may be of similar diameter (though usually the syrup chamber will be of slightly smaller diameter) and the axial extent of the chambers will vary substantially, the axial extent of the syrup chamber being, e.g., from 10 to 40% only of the axial extent of the carbonated water chamber.

In a preferred form of pump, the impeller members consist of a central rotor and a plurality of vanes mounted on the exterior of the rotor, each vane being swivellable about an axis parallel with the axis of the rotor, and with the swivelling of the vanes being limited at certain parts of the chamber by abutment with deflector members located on the exterior wall of the chamber which, in such arrangements, varies from being circular cylindrical.

In a particularly preferred arrangement, the chamber may have an asymmetric outline, and be rotatable about the axis of the rotor relative to the inlet and outlet ports so that the deflector members act on the vanes at a different point circumferentially. Since the inlet and outlet ports are fixed, changing the deflection of the vanes as they sweep out a path between inlet and outlet port changes the volumetric displacement per revolution of the rotor. By arranging a pump in this way, fine control of the ratio of carbonated water to syrup dispensed via the outlets from the two pump chambers may be achieved.

Thus, in accordance with a separate feature of the present invention, there is provided a proportioning pump consisting of pump housing having a pair of coaxial separate pump chambers, each chamber having an, axial extent and having an impeller mounted in it, the impeller consisting of a central body and a plurality of vanes which may extend outwardly from the central body to contact the exterior wall of the chamber, and wherein at least one of the exterior walls, is non-circular, so that the degree of radial extension of each outwardly extending vane varies as it sweeps the area of the chamber between inlet and outlet port, wherein one planar wall of the chamber contains inlet and outlet ports and the other planar wall of the chamber is rotatable about the axis of rotation of the impeller and relative to the wall containing the inlet and outlet ports.

Such a proportioning pump may be operated, analogously to the dispensing pump described above, by driving the impeller by introducing liquid under pressure into the inlet of one of the pump chambers. However, it is also possible to provide that the proportioning pump is driven by, for example, an external source of power arranged to rotate the impellers.

These and further features of the present invention will become more easily understood by the following description of beverage dispensing apparatus in accordance with the present invention taken in conjunction with the accompanying drawings.

In these drawings:

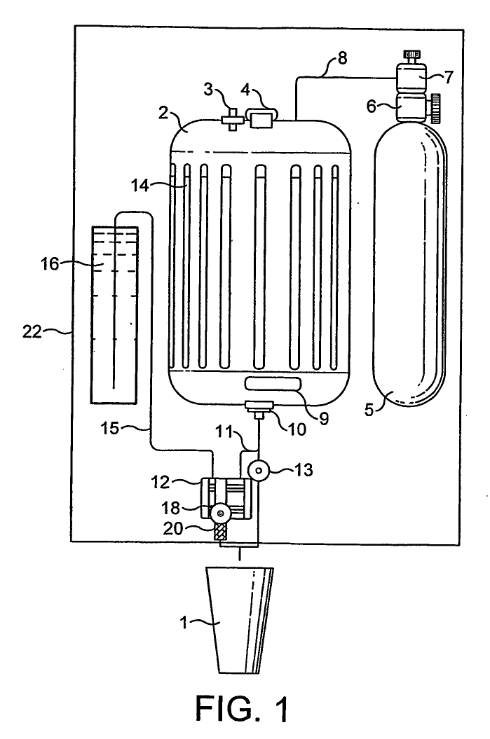

FIG. 1 is a diagrammatic drawing showing beverage mixing and dispensing apparatus in accordance with the present invention.

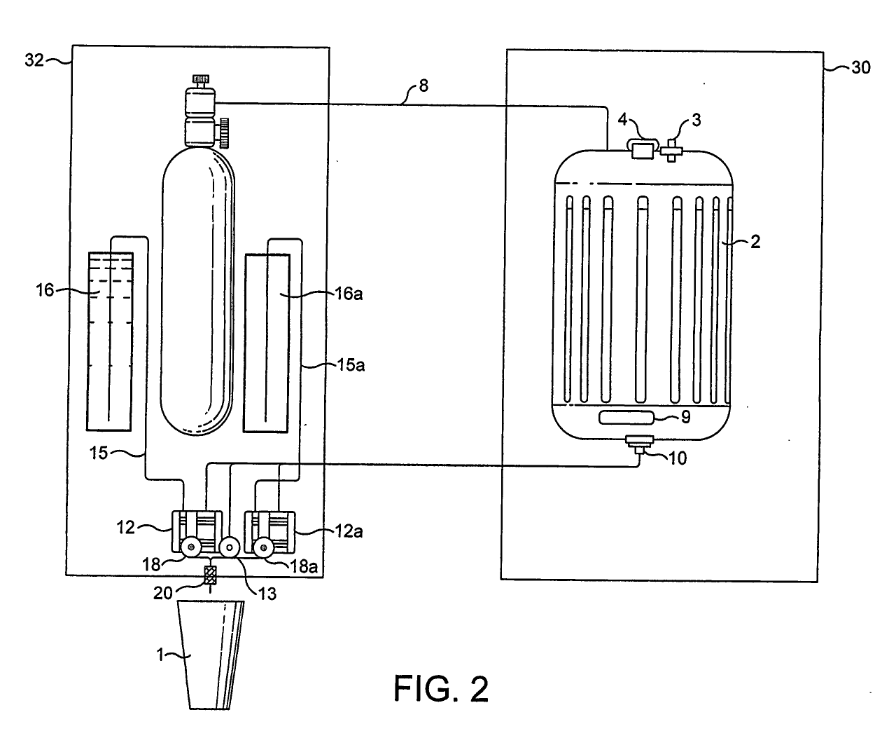

FIG. 2 is a diagrammatic representation of an alternative form of beverage mixing and dispensing apparatus in accordance with the present invention.

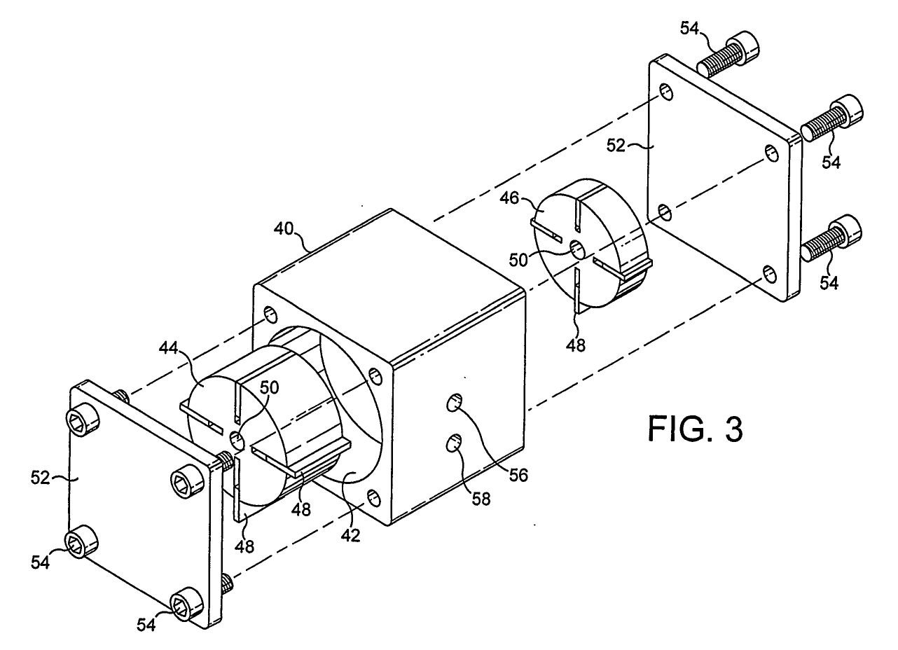

FIG. 3 is an exploded diagrammatic view of a pump used in the apparatus show in FIG. 1 or 2.

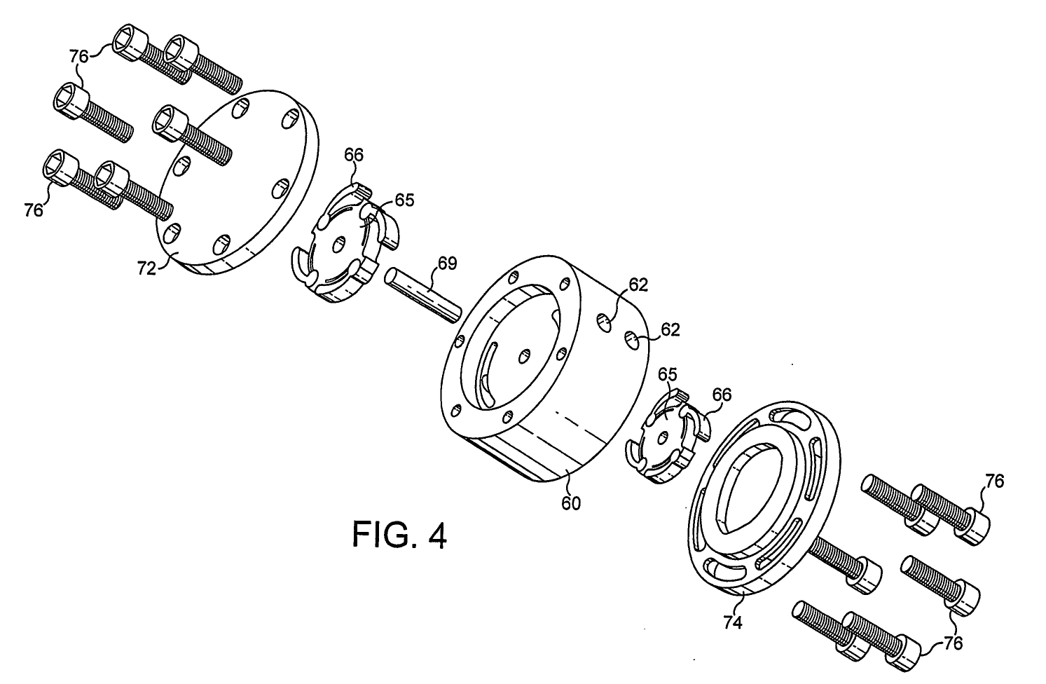

FIG. 4 is an exploded view of an alternative pump construction.

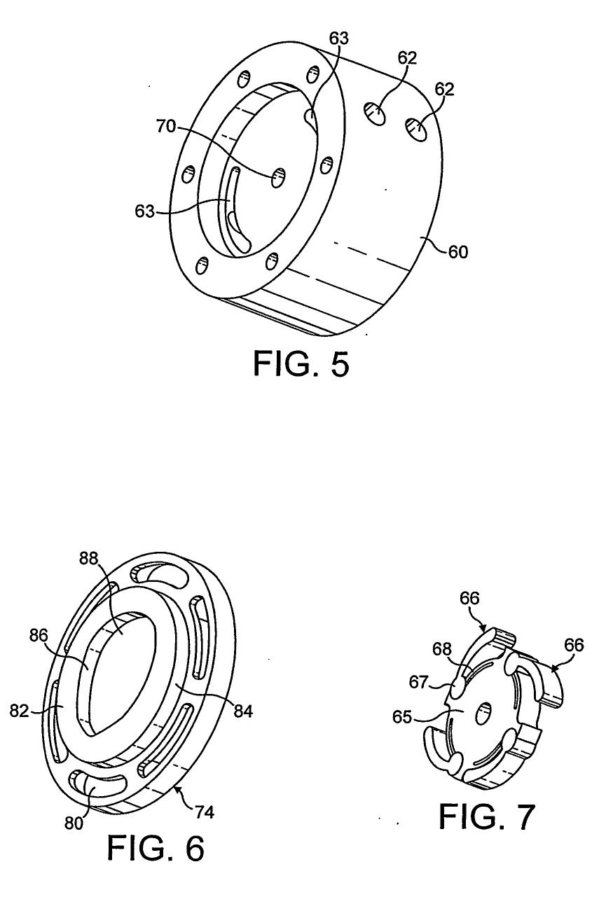

FIG. 5 is a diagrammatic view of the central body member of the pump shown in FIG. 4.

FIG. 6 is a perspective view of one end plate of the pump shown in FIG. 4 and

FIG. 7 is a perspective view of the impeller of the pump shown in FIG. 4 which cooperates with the end plate shown in FIG. 5.

Referring to FIG. 1 of the drawings, this shows a simple arrangement for dispensing carbonated beverages. The beverages are to be dispensed into a cup 1 which is shown and located beneath the device itself and are made by mixing carbonated water with beverage syrup. The water is contained in a central reservoir tank 2 which is provided at its upper end with a filler cap 3 and a pressure release valve 4 and with exterior fins 14 to assist heat transfer between the tank 2 and its surroundings. The water in the tank 2 may be carbonated by injecting carbon dioxide under pressure from a standard cylinder 5 thereof which has a fitted shut-off valve 6 and pressure reduction valve 7, the outlet of which is connected via a tube 8 to the top of water tank 2. The tube 8 extends towards the bottom of the tank and terminates in a diffuser block 9 enabling carbon dioxide from tank 5 to be dispersed in the water in tank 2.

At the bottom of tank 2 there is an outlet 10 connected via a lead 11 to a proportioning pump 12 and separately via a release valve 13 to an outlet located above beverage container 1. Pressing release valve 13 allows carbonated water (soda water) to be dispensed directly if desired.

Pump 12 has two pumping chambers, the right hand one of which as shown in FIG. 1 is connected to the water tank and the left hand one is connected via a lead 15 to a syrup container 16. The outlets from pump 12 may be released by a common actuator 18 which lies between pump 12 and a mixing tube 20, the outlet end of which connects to the outlet tube above beverage container 1.

When actuator 18 is actuated, it allows the water under pressure to pass through the right hand pump chamber and into the mixer 20. At the same time, because the right hand pump chamber is driven by the carbonated water flow, an impeller in the left hand pump chamber is likewise driven and this sucks syrup from container 16 via tube 15 enabling that syrup to reach mixer 20. The syrup and carbonated water are mixed in mixer 20 to form the carbonated beverage.

The external box denoted 22 in FIG. 1 may be thought of as a refrigerated container which keeps the water in tank 2 at an appropriate temperature.

FIG. 2 shows analogous apparatus and like components are denoted by the same reference numbers. In contrast to the arrangement shown in FIG. 1, that in FIG. 2 shows the water tank 2 in a separated refrigerated compartment 30 and the syrup containers, carbon dioxide source and proportioning pumps in a separate housing 32. As can be seen, there are three release valves, the first denoted 13 being for dispensing soda water as described above, and the others denoted 18 and 18a acting to dispense a carbonated beverage formed by mixing carbonated water with the syrup in a first syrup container 16 or a secondary syrup container 16a, each feeding syrup into one of a pair of proportioning pumps 12, 12a via lines 15, 15a respectively.

As can be seen, the outlets of all three release valves 13, 18 and 18a feed together into the mixing tube 20 located above the beverage container 1.

FIG. 3 is an exploded view of a simple form of pump which can be used in the beverage mixing and dispensing apparatus shown in FIGS. 1 and 2. The pump consists basically of a central block 40 having two cylindrical chambers formed in it extending from opposite sides. The cylindrical chamber visible in the drawing, denoted 42, is of greater axial extent than the one on the other side of block 40. Between the two cylindrical chambers is an eccentric axial bore through which a shaft (not shown in the drawing) extends which connects together to impeller bodies 44 and 46. Each of bodies 44 and 46 consists of a cylindrical block having four radial slots in each of which is located a slidable vane 48, each vane being biased radially outwardly by a suitable spring located between the base of the slot and the vane itself. Each block also has a central aperture 50 for receipt of a drive shaft which connects the two together when the pump is assembled. Because the drive shaft passes through the bore between the two cylindrical chambers, when one body 44 is rotated, the other body 46 rotates as well.

Because the bore in the block through which the shaft passes is eccentric relative to chamber 42 and the opposite chamber on the other side of the block, the vanes extend different amounts from each cylindrical block 44, 46 irrespective of the position of the blocks themselves. The outer radial edges of vanes 48 seal against the interior wall of chamber 42 and the opposite chamber. Axially, each block 44, 46 is a close fit in the respective chamber 42 and the opposite one, and is held captive by way of an end plate 52 which is held on to block 40 by a plurality of threaded bolts 54.

Internally of block 40, there are a number of channels through which liquid may pass and these are connected to inlet and outlet ports on the outside of the block. Two of these are shown diagrammatically and denoted 56 and 58 and they connect with ports at the outer edge of the circular bases of chamber 42 and the chamber opposite it.

Once the pump block is all assembled together, putting water under pressure into the inlet of chamber 42 will, provided the outlet enables water to flow out, cause the impeller body 44 to rotate with vanes 48 being driven to sweep round the chamber 42 between impeller body 44 and its outer cylindrical wall, thus enabling the pressurised carbonated water to flow through the pump housing and into the mixing unit where it and the syrup mix. Because rotation of impeller body 44 causes rotation of impeller body 46, the syrup is pumped from a syrup inlet port to a syrup outlet port at the same time. Because of the different axial extents of the impeller bodies 44 and 46, the proportion of carbonated water in the mixture is greater than that of syrup. Thus, the specific dimensions of the pump shown exploded in FIG. 3 determine the mixing ratio. It would be possible to vary the mixing ratio by exchanging one impeller body for another, for example where the diameter of body 44 or 46 differed so that the amount of free volume in each chamber was different.

The structure of the pump unit shown in FIG. 3 is straightforward to disassemble and re-assemble which is necessary for cleaning purposes, particularly if the unit is to be changed over from mixing one sort of syrup to mixing a different sort, in each case with carbonated water.

Referring now to FIG. 4, this shows a dispensing pump of slightly different construction and where, within given limits, adjustment of the mixing ratio is achievable without the unit having to be disassembled.

As shown in exploded view in FIG. 4, the pump consists of a central pump body 60 of generally cylindrical shape and having a cylindrical cavity in each end which acts as a pumping chamber. As can be seen more clearly in FIG. 5, the circular base of the pumping chamber has inlet and outlet ports 63 which are connected to respective ports 62 in the side of pump body 60.

In each pump chamber there is an impeller consisting of a central body 65 and four vanes 66. Each vane 66 has a cylindrical root 67 (visible in FIG. 7) which sits snugly in a part-cylindrical recess in the body 65. By means of a sprung leaf 68 formed integrally with body 65, each vane 66 is urged so that its distal end contacts the outer cylindrical wall of the respective pumping chamber. The two bodies 65 are connected together via a pin 69 which passes through a bore 70 in block 60.

As in the case of the pump shown in FIG. 3, the ends of the housing are closed by end plates denoted 72 and 74 in FIG. 4 and held against the ends of main body 60 by means of a series of six threaded fastening bolts 76.

The end plate 72 covers the chamber through which the culminated water passes under pressure, the water entering through one port 63 and leaving the chamber through the other port 63. In doing so, it acts to turn body 65 carrying vanes 66.

Via pin 69, both bodies 65 turn and, as a consequence, the impeller located against plate 74 also turns. Plate 74, however, has a construction different from plate 72, the specific construction being evident from the perspective view of it shown in FIG. 6. As can be seen from that Figure, plate 74 has six arcuate slots 80 in its outer periphery. On its interior face, it has a raised ring 82, the exterior surface 84 of which is a cylindrical surface fitting into the cylindrical cavity or chamber formed in block 60. Its interior face 86 is, however, non-cylindrical. When plate 74 is attached to body 60, the impeller 65 lies with its vanes 66 lying against this surface 86.

The inlet and outlet ports for syrup which are adjacent the circular base of the cavity in block 60 are located to lie within the outline of surface 86 which can be thought of as a non-cylindrical wall for the pumping chamber.

The orientation of the asymmetric chamber formed by wall 86, the wall of the cavity in block 60 and the inner surface of plate 74 (denoted 88 in FIG. 6) constitutes an asymmetrical pumping chamber which can be rotated relative to the axis of block 60 (which includes inlet and outlet port 63) thus varying the position of the asymmetric chamber relative to those inlet and outlet ports. The degree of rotation is determined by the arcuate extent of slots 80.

Thus by rotating the end plate 74, the amount of liquid swept from inlet to outlet port as the impeller 65 with its vanes 66 rotates can be varied.

1. A carbonated beverage dispensing apparatus comprising a dispensing pump housing including a pair of generally cylindrical pump chambers, fluid impeller means rotated about the axes of each chamber, the impellers being linked together for common rotation, and wherein each cylindrical chamber has a fluid inlet and a fluid outlet, the respective fluid inlets being connectable to a source of syrup and a source of carbonated water under pressure, and the outlets of the two chambers being brought together to cause syrup and carbonated water to mix to produce the desired beverage, each impeller being in the form of a central body having movable vanes thereon, the ends of the vanes distal from the central body being adapted to sweep round the exterior cylindrical surface of the respective chamber.

2. A carbonated beverage dispensing apparatus according to claim 1 wherein the vanes are spring biased outwardly to ensure contact of the outer ends of the vanes with the outer periphery of the chambers.

3. A carbonated beverage dispensing apparatus according to claim 1 or 2 wherein the outlets are brought together in an appropriate mixing chamber or mixing valve.

4. A carbonated beverage dispensing apparatus according to and one of claims 1 to 3 wherein the chambers are coaxial and a common shaft rigidly connects the two impellers

5. A carbonated beverage dispensing apparatus according to any of claims 1 to 4 wherein the chambers are of similar diameter or the diameter of the syrup chamber is smaller and the axial extent of the syrup chamber is from 10 to 40% of the axial extent of the carbonated water chamber.

6. A carbonated beverage dispensing apparatus according to any one of the preceding claims wherein the impeller members consist of a central rotor and a plurality of vanes mounted on the exterior of the rotor, each vane being swivellable about an axis parallel with the axis of the rotor, and with the swivelling of the vanes being limited at certain parts of the chamber by abutment with deflector members located on the exterior wall of the chamber which is not a circular cylindrical shape

7. A carbonated beverage dispensing apparatus according to claim 6 wherein the chamber has an asymmetric outline, and is rotatable about the axis of the rotor and relative to the inlet and outlet ports so that the deflector members act on the vanes at a different point circumferentially

8. A proportioning pump consisting of pump housing having a pair of coaxial separate pump chambers, each chamber having an axial extent and having an impeller mounted in it, the impeller consisting of a central body and a plurality of vanes which may extend outwardly from the central body to contact the exterior wall of the chamber, and wherein at least one of the exterior walls, is non-circular, so that the degree of radial extension of each outwardly extending vane varies as it sweeps the area of the chamber between inlet and outlet port, wherein one planar wall of the chamber contains inlet and outlet ports and the other planar wall of the chamber is rotatable about the axis of rotation of the impeller and relative to the wall containing the inlet and outlet ports

9. A proportioning pump according to claim 7 and including means for driving the impellers in rotation.
